(19) United States
(12) Patent Application Publication
(10) Pub. No.: US 2026/0247077 A1
(43) Pub. Date: Aug. 20, 2026

(54) LOUDSPEAKER

(71) Applicant: MERRY ELECTRONICS (SUZHOU) CO., LTD., Jiangsu Province (CN)

(72) Inventors: Jiawei Zhu, Jiangsu Province (CN); Mingya Luo, Jiangsu Province (CN)

(73) Assignee: MERRY ELECTRONICS (SUZHOU) CO., LTD., Jiangsu Province (CN)

(21) Appl. No.: 19/448,828

(22) Filed: Jan. 14, 2026

(30) Foreign Application Priority Data
Feb. 18, 2025 (CN) 202520259483.0
Feb. 18, 2025 (CN) 202520260268.2

(51) Int. Cl. H04R 9/02; H04R 1/06; H04R 1/24; H04R 7/18; H04R 9/04; H04R 9/06

(52) U.S. Cl. CPC H04R 9/025; H04R 1/06; H04R 1/24; H04R 7/18; H04R 9/045; H04R 9/047; H04R 9/06; H04R 2207/021

(57) ABSTRACT

Provided is a loudspeaker. The loudspeaker includes: a seat, a moving member, and a magnetic assembly. The seat has an accommodating cavity. The moving member includes a first diaphragm and a first voice coil arranged on the first diaphragm. The first voice coil and at least a part of the first diaphragm are located in the accommodating cavity. The magnetic assembly includes a first magnetic member and a second magnetic member arranged opposite to each other. The first magnetic member and the second magnetic member are arranged on an outer side of the seat. A first magnetic gap is formed between the first magnetic member and the second magnetic member, and at least a part of the first voice coil is located in the first magnetic gap.

### CROSS-REFERENCE TO RELATED APPLICATION

This application claims the benefits of Chinese Patent Application No. 202520260268.2, filed on February 18, 2025, entitled “Loudspeaker” and Chinese Patent Application No. 202520259483.0, filed on February 18, 2025, entitled “Loudspeaker”, which are incorporated herein by reference in its entirety.

### FIELD

The present disclosure relates to a loudspeaker.

### BACKGROUND

In a traditional loudspeaker, a vibration system and a magnetic circuit system are respectively located on upper and lower sides, thus reserving more space for movement of a voice coil. As a result, the loudspeaker occupies an excessively large volume. In addition, the magnetic circuit system is located inside the loudspeaker, which is also unfavorable for spatial arrangement of the loudspeaker and other parts. How to reduce the volume and optimize spatial arrangement of the loudspeaker has become a problem that needs to be solved.

### SUMMARY

Embodiment of the present disclosure provides a loudspeaker.

The loudspeaker of the present disclosure includes: a seat, a moving member, and a magnetic assembly. The seat has an accommodating cavity. The moving member includes a first diaphragm and a first voice coil arranged on the first diaphragm. The first voice coil and at least a part of the first diaphragm are located in the accommodating cavity. The magnetic assembly includes a first magnetic member and a second magnetic member. The first magnetic member and the second magnetic member are arranged opposite to each other. The first magnetic member and the second magnetic member are arranged on an outer side of the seat. A first magnetic gap is formed between the first magnetic member and the second magnetic member, and at least a part of the first voice coil is located in the first magnetic gap.

### BRIEF DESCRIPTION OF DRAWINGS

The above and other objectives, features and advantages of the present disclosure will become more apparent from the following description of the embodiments of the present disclosure with reference to the accompanying drawings, in which:

FIG. 1 is a schematic structural diagram of a loudspeaker viewing from a side provided by a first embodiment of the present disclosure;

FIG. 2 is a schematic structural diagram of the loudspeaker viewing from another side provided by the first embodiment of the present disclosure;

FIG. 3 is a schematic exploded diagram of the loudspeaker provided by the first embodiment of the present disclosure;

FIG. 4 is a cross-section schematic diagram of the loudspeaker provided by the first embodiment of the present disclosure;

FIG. 5 is a schematic structural diagram of a magnetic assembly provided by the first embodiment of the present disclosure;

FIG. 6 is a schematic structural diagram of a loudspeaker provided by a second embodiment of the present disclosure;

FIG. 7 is a schematic exploded diagram of the loudspeaker provided by the second embodiment of the present disclosure;

FIG. 8 is a partial cross-section schematic diagram of the loudspeaker provided by the second embodiment of the present disclosure;

FIG. 9 is a schematic structural diagram of a loudspeaker provided by a third embodiment of the present disclosure;

FIG. 10 is a schematic exploded diagram of the loudspeaker provided by the third embodiment of the present disclosure;

FIG. 11 is a partial cross-section schematic diagram provided by the third embodiment of the present disclosure;

FIG. 12 is a schematic structural diagram of a connecting member provided by a fourth embodiment of the present disclosure;

FIG. 13 is a schematic exploded diagram of the connecting member provided by the fourth embodiment of the present disclosure;

FIG. 14 is a schematic exploded diagram of the connecting member and a first housing provided by the fourth embodiment of the present disclosure; and

FIG. 15 is a schematic exploded diagram of a loudspeaker provided by a fifth embodiment of the present disclosure.

### DETAILED DESCRIPTION OF THE EMBODIMENTS

The following describes the present disclosure based on embodiments, but the present disclosure is not limited to these embodiments. In the following detailed description of the present disclosure, some specific details are described in detail. Those skilled in the art may also fully understand the present disclosure without the descriptions of the details. In order to avoid confusing the substance of the present disclosure, well-known methods, processes, procedures, elements, and circuits are not described in detail.

In addition, those of ordinary skill in the art should understand that the drawings provided herein are for illustrative purposes and are not necessarily drawn to scale.

Unless the context clearly requires otherwise, similar words such as “including” and “comprising” throughout the application document should be interpreted as inclusive rather than exclusive or exhaustive; that is to say, it means “including but not limited to”.

In the description of the present disclosure, it should be understood that the terms “first”, “second”, and the like are used for descriptive purposes only and cannot be construed as indicating or implying relative importance. In addition, in the description of the present disclosure, the term “a plurality of” means two or more, unless otherwise stated.

Unless otherwise specified and limited, the terms “mounted”, “connected”, “connection”, “fixed”, and the like should be understood broadly. For example, the “connection” may be a fixed connection, a detachable connection, or an integrated connection, may be a direct connection or an indirect connection by means of an intermediate medium, or may be an internal connection of two elements or an interaction between two elements. For those of ordinary skill in the art, specific meanings of the above terms in the present disclosure can be understood according to specific circumstances.

For ease of description, the spatially relative terms such as “in”, “out”, “under”, “below”, “lower”, “above”, “upper”, etc., are used to describe a relationship between one element or feature and another element or feature shown in the figures herein. It will be understood that spatially related terms may be intended to include different orientations of a device in use or operation in addition to the orientation depicted in the figures. For example, if the device in the figures is flipped, it is described that elements “below” or “under” other elements or features are positioned to be “above” other elements or features. Therefore, exemplary terms “below” can include both orientations of “above” and “below”. The device be otherwise oriented (rotated 90 degrees or at other orientations) and the spatially relative descriptors used herein may likewise be interpreted accordingly.

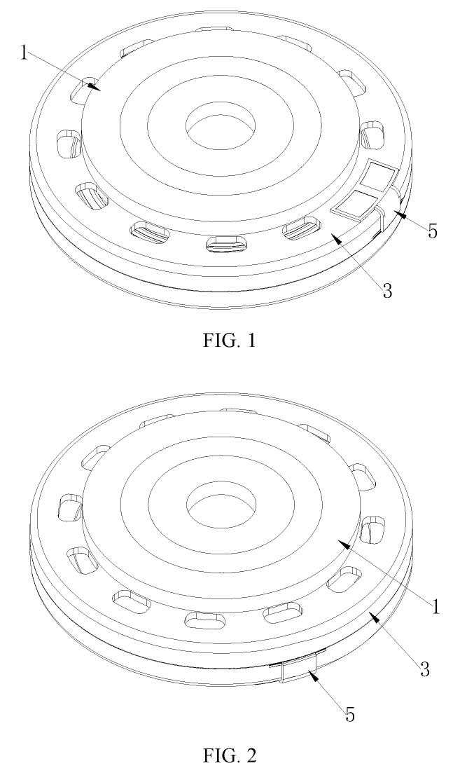

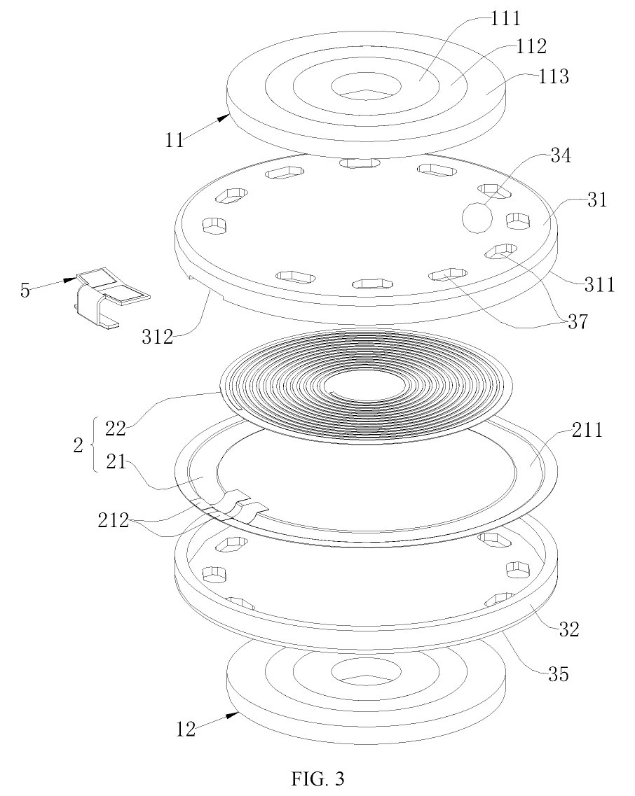

FIG. 1 and FIG. 2 are schematic structural diagrams of a loudspeaker provided by a first embodiment. FIG. 3 is a schematic exploded diagram of the loudspeaker provided by the first embodiment.

As shown in FIGS. 1-3, the loudspeaker in this embodiment includes a magnetic assembly 1, a moving member 2, a seat 3, and a connecting member 5. The magnetic assembly 1 is arranged on an outer side of the seat 3, and the seat 3 has an accommodating cavity 33 for accommodating the moving member 2. The moving member 2 includes a first diaphragm 21 and a first voice coil 22 fixedly connected to the first diaphragm 21. The first voice coil 22 and at least a part of the first diaphragm 21 are located in the accommodating cavity 33.

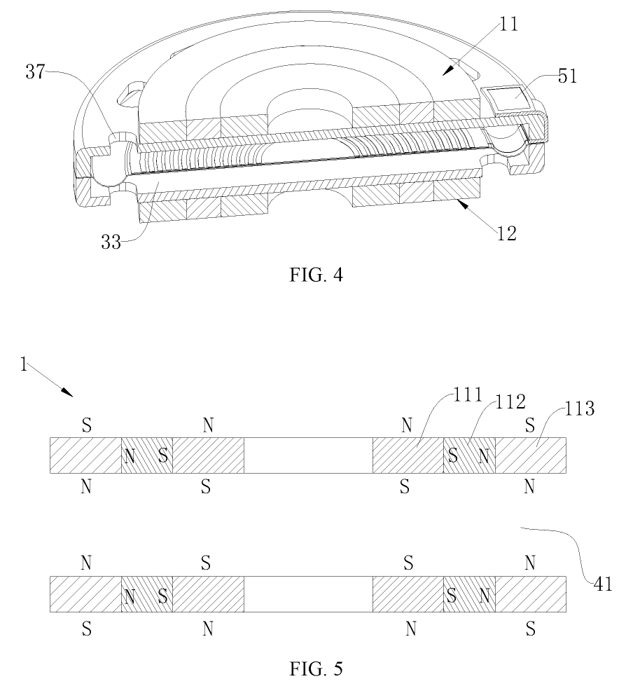

FIG. 4 is a cross-section schematic diagram of the loudspeaker provided by the first embodiment. FIG. 5 is a schematic structural diagram of a magnetic assembly 1 provided by the first embodiment.

Referring to FIGS. 4-5, the magnetic assembly 1 includes a first magnetic member 11 and a second magnetic member 12 spaced apart from and arranged opposite to each other. The magnetic member 11 and the second magnetic member 12 are arranged on an outer side of the seat 3, and opposite sides of the magnetic member 11 and the second magnetic member 12 form a first magnetic gap 41. At least a part of the first voice coil 22 is arranged in the first magnetic gap 41. After a control circuit supplies power to the first voice coil 22, the first voice coil 22 in the first magnetic gap 41, under the action of an Ampere force, moves back and forth between the first magnetic member 11 and the second magnetic member 12, thereby driving the first diaphragm 21 to vibrate.

In the loudspeaker of this embodiment, the first voice coil 22 and the first diaphragm 21 are arranged in the accommodating cavity 33, and the first magnetic member 11 and the second magnetic member 12 are arranged outside of the seat 3 at an interval. Thus, by utilizing the first magnetic gap 41 between the first magnetic member 11 and the second magnetic member 12, the first voice coil 22, under the action of an Ampere force, drives the first diaphragm 21 to vibrate. In this way, a volume occupied by the magnetic assembly 1 in the accommodating cavity 33 and distortion of the loudspeaker are reduced, making installation of the loudspeaker more convenient. Meanwhile, a magnetic field generated by the magnetic assembly 1 outside of the seat 3 can facilitate electronic elements around the loudspeaker to share the magnetic assembly 1, thereby increasing a degree of integrating the surrounding electronic elements to the loudspeaker and further reducing a cost of a product.

As shown in FIG. 3, the first voice coil 22 is a planar voice coil. The first voice coil 22 may be a double-sided etched coil. For example, a coil is formed by etching a flexible copper-clad laminate, and the etched flexible copper-clad laminate is then attached to the first diaphragm 21 using glue. Alternatively, the first voice coil 22 may be directly formed on the first diaphragm 21 by chemical etching and other methods.

In some embodiments, the first voice coil 22 may be formed by directly winding a copper wire, and the formed first voice coil 22 is fixed to the first diaphragm 21.

In some embodiments, as shown in FIG. 3, the seat 3 has a first installing surface 34 and a second installing surface 35, which are located on outer surfaces of the seat 3, facing opposite directions. Referring to FIG. 4, the first magnetic member 11 is installed on the first installing surface 34, and the second magnetic member 12 is installed on the second installing surface 35.

For example, the seat 3 is cylindrical. The first installing surface 34 and the second installing surface 35 are planar. The first magnetic member 11 and the second magnetic member 12 are adhered to the first installing surface 34 and the second installing surface 35 by glue respectively. Thus, the magnetic assembly 1 does not occupy any space in the accommodating cavity 33, and the electronic elements outside of the seat 3 can also reuse a magnetic force generated by the magnetic assembly 1, thereby increasing an integration level of a device.

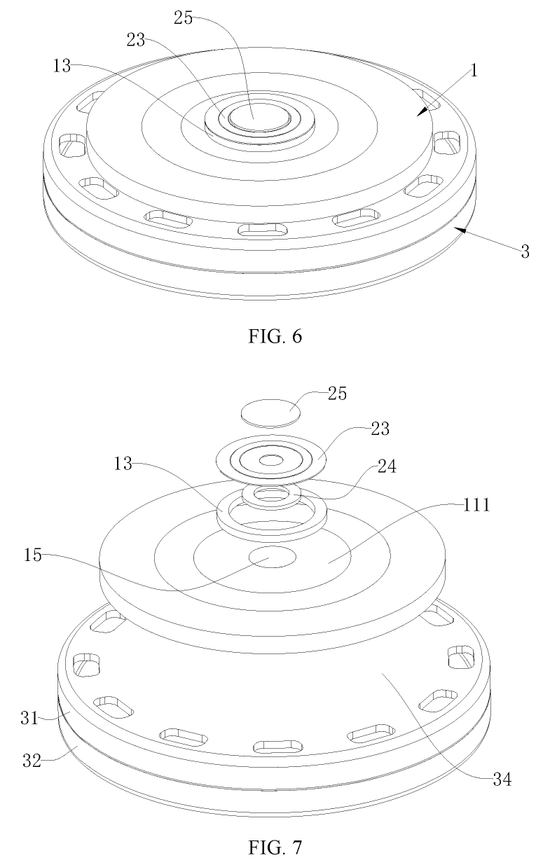

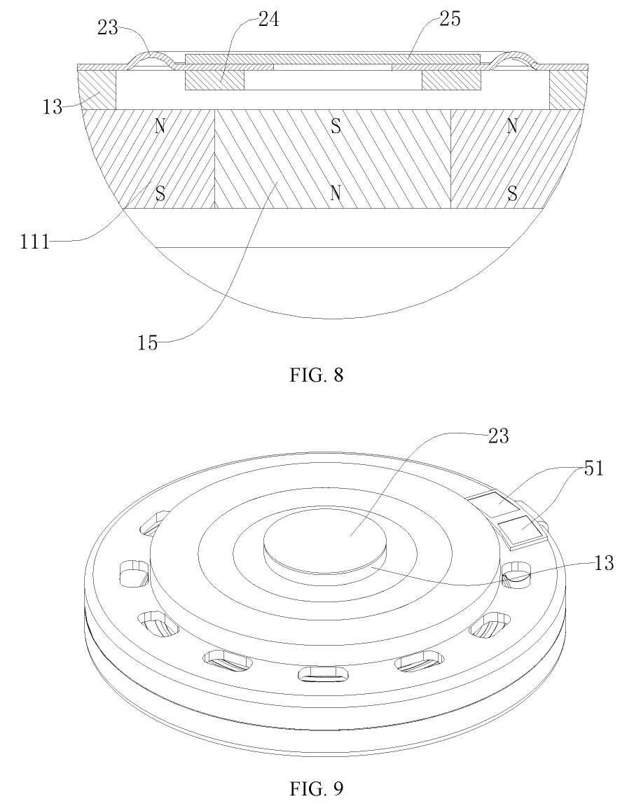

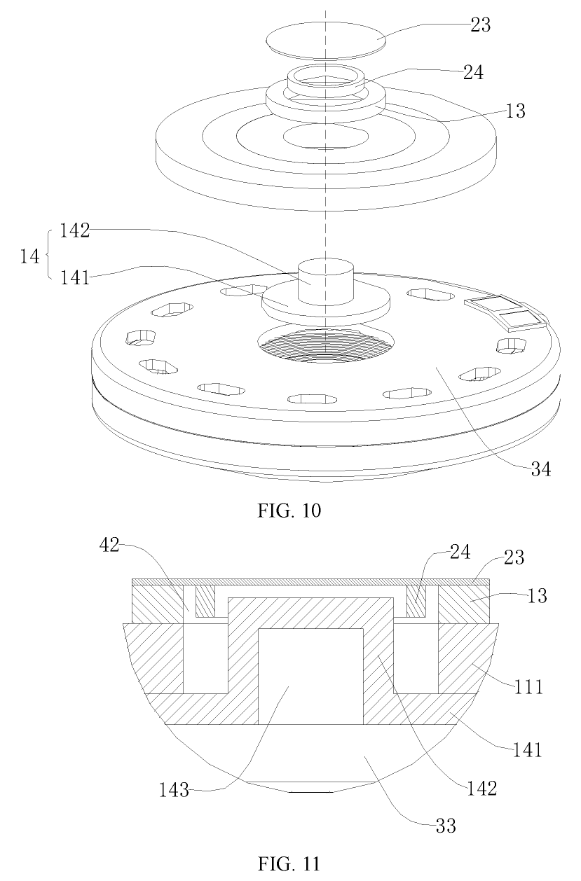

FIG. 6 is a schematic structural diagram of a loudspeaker provided by a second embodiment. FIG. 7 is a schematic exploded diagram of the loudspeaker provided by the second embodiment. FIG. 8 is a partial cross-section schematic diagram of the loudspeaker provided by the second embodiment. FIG. 9 is a schematic structural diagram of a loudspeaker provided by a third embodiment. FIG. 10 is a schematic exploded diagram of the loudspeaker provided by the third embodiment. FIG. 11 is a partial cross-section schematic diagram provided by the third embodiment.

As shown in FIGS. 6-11, the moving member 2 further includes a second diaphragm 23 and a second voice coil 24. The second voice coil 24 is fixedly connected to the second diaphragm 23 and arranged on one side, away from the accommodating cavity 33, of the first magnetic member 11, and at least a part of the second voice coil 24 is located within a magnetic field of the magnetic assembly 1.

In this embodiment, the first diaphragm 21, the first voice coil 22, and the magnetic assembly 1 form a low-frequency sound generation unit, while the second diaphragm 23, the second voice coil 24, and either the first magnetic member 11 or the second magnetic member 12 form a high-frequency sound generation unit. In this way, the low-frequency sound generation unit and the high-frequency sound generation unit can supply sound waves in different frequency domains to the loudspeaker, thereby increasing the loudspeaker's loudness. In this embodiment, the loudspeaker can be applied to an earphone.

In some embodiments, there are two second diaphragms 23 and two second voice coils 24. One second diaphragm 23, one second voice coil 24 and the first magnetic member 11 form a first high-frequency sound generation unit, and the other second diaphragm 23, the other second voice coil 24 and the second magnetic member 12 form a second high-frequency sound generation unit. In this way, the loudness of high-frequency sound waves is further increased.

In some embodiments, as shown in FIGS. 6-11, the magnetic assembly 1 further includes a magnetic permeance washer 13. The magnetic permeance washer 13 is attracted to the first magnetic member 11, the second diaphragm 23 is fixedly connected to one side, away from the first magnetic member 11, of the magnetic permeance washer 13, and the second voice coil 24 is fixed to one side, close to the first magnetic member 11, of the second diaphragm 23 and located on an inner side of the magnetic permeance washer 13.

In this embodiment, the magnetic permeance washer 13 improves a magnetic field generated by the first magnetic member 11, so that the second voice coil 24 is suitably arranged within the magnetic field of the first magnetic member 11. In addition, the magnetic permeance washer 13 also keeps the second voice coil 24 spaced apart from the first magnetic member 11, ensuring a sufficient moving space between the second voice coil 24 and the first magnetic member 11.

In some embodiments, as shown in FIGS. 6-8, the first magnetic member 11 includes a first magnetic ring 111, and the magnetic permeance washer 13 is attracted to the first magnetic ring 111. At least a part of the second voice coil 24 is spaced apart from and arranged opposite to the first magnetic ring 111. The second voice coil 24 is configured as a planar voice coil, so as to reduce the dimension of the second voice coil 24 in an axial direction of the first magnetic ring 111 and prevent a collision between the second voice coil 24 and the first magnetic ring 111.

In some embodiments, as shown in FIGS. 7-8, the first magnetic member 11 further includes a central magnet 15, which is located in a center of the first magnetic ring 111 and is attracted to the first magnetic ring 111. The second voice coil 24 is arranged opposite to both the central magnet 15 and the first magnetic ring 111. In this embodiment, the central magnet 15 strengthens an overall magnetic force of the magnetic assembly 1, so that stronger Ampere force acts on the second voice coil 24.

In some embodiments, a circular cover 25 is provided on one side, away from the accommodating cavity 33, of the second diaphragm 23, and the circular cover 25 optimizes vibration of the second diaphragm 23 and further improves a sound quality of the high-frequency sound generation unit.

In some embodiments, as shown in FIGS. 9-11, the first magnetic member 11 includes the first magnetic ring 111, and the magnetic permeance washer 13 is attracted to the first magnetic ring 111. The magnetic assembly 1 further includes a central magnetic permeance member 14. The central magnetic permeance member 14 includes an inner plate 141 and a cylinder 142. The inner plate 141 is located on one side, close to the accommodating cavity 33 of the first magnetic ring 111 and attracted to the first magnetic ring 111. The cylinder 142 extends outward from a center of the first magnetic ring 111, a part of the cylinder 142 and an opposite side of the magnetic permeance washer 13 form a second magnetic gap 42, and at least a part of the second voice coil 24 is located in the second magnetic gap 42.

In some embodiments, the magnetic permeance washer 13 and the central magnetic permeance member 14 may be made from materials such as silicon steel, ferrite, or iron-boron alloys. After the magnetic permeance washer 13 and the central magnetic permeance member 14 are attracted to the first magnetic member 11, a part of the magnetic force of the magnetic assembly 1 can act on the second voice coil 24 through the second magnetic gap 42. In this way, the Ampere force acting on the second voice coil 24 is optimized.

In some embodiments, an avoidance hole is formed in a center of the first installing surface 34, and the avoidance hole penetrates through a first housing 31. The inner plate 141 is circular and located in the avoidance hole. The first magnetic ring 111 has an outer edge lapped on the first installing surface 34 and an inner edge opposite to a part of the avoidance hole. The cylinder 142 extends from the inner plate 141 toward an outer side of the accommodating cavity 33 and passes through the first magnetic ring 111, and the end portion of the cylinder 142 is arranged opposite to a part of the magnetic permeance washer 13. The cylinder 142 has a groove 143, an inner surface of the groove 143 and an outer surface of the cylinder 142 are both cylindrical surfaces, thereby further optimizing conduction of the magnetic field along the central magnetic permeance member 14.

In some embodiments, the inner side surface of the magnetic permeance washer 13 and the inner side surface of the first magnetic ring 111 are both cylindrical surfaces, overlapping axially. The second voice coil 24 is configured as a cylindrical voice coil. As a result, the first magnetic ring 111 can avoid the second voice coil 24 and make the magnetic field within the second magnetic gap 42 more uniform.

In some embodiments, as shown in FIGS. 1-4, the seat 3 further includes a first housing 31 and a second housing 32. The first housing 31 and the second housing 32 are connected to form the accommodating cavity 33. The loudspeaker further includes a connecting member 5.

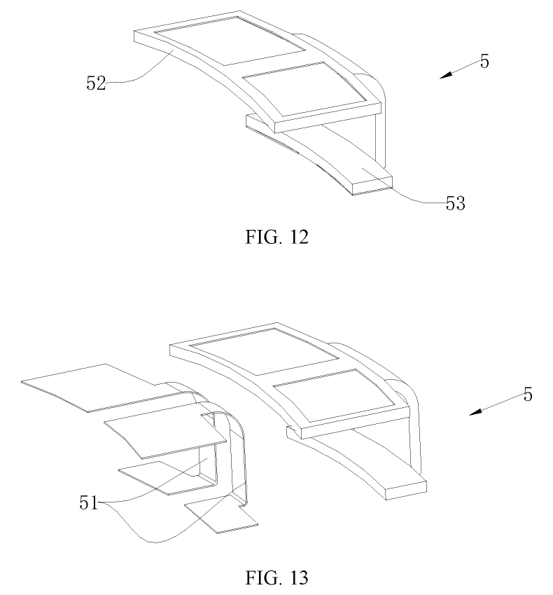

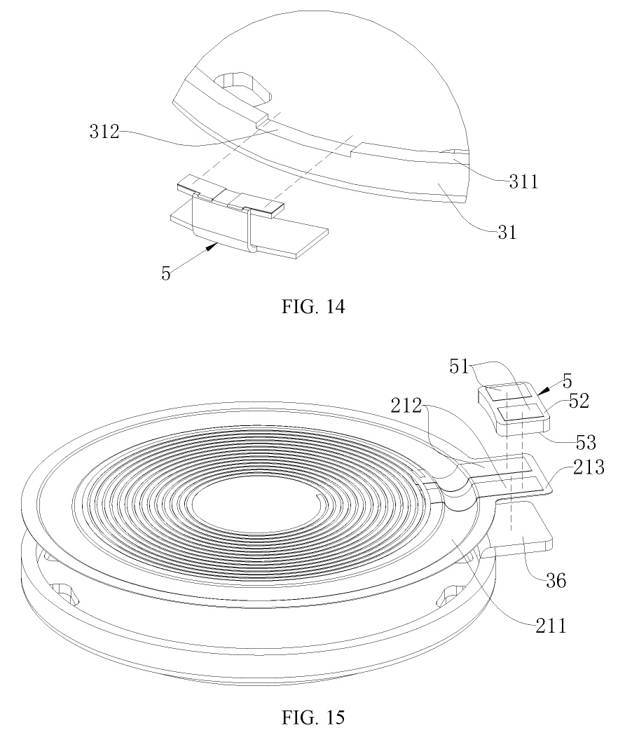

FIG. 12 is a schematic structural diagram of a connecting member 5 provided by a fourth embodiment. FIG. 13 is a schematic exploded diagram of the connecting member 5 provided by the fourth embodiment. FIG. 14 is a schematic exploded diagram of the connecting member 5 and a first housing 31 provided by the fourth embodiment. FIG. 15 is a schematic exploded diagram of a loudspeaker provided by a fifth embodiment.

Referring to FIGS. 12-15, the connecting member 5 is arranged on the seat 3 and has two electrical paths 51, and each electrical path 51 has one end located on the outer side of the seat 3 and another end electrically connected to the first voice coil 22. In this embodiment, with the connecting member 5, the control circuit can supply power to the first voice coil 22 located inside the accommodating cavity 33, thereby controlling vibration of the moving member 2. In this way, a connecting mode of the loudspeaker is simplified.

In some embodiments, as shown in FIG. 3 and FIG. 15, the first diaphragm 21 includes a diaphragm film 211 and two conductive patterns 212 formed on the diaphragm film 211, and the two conductive patterns 212 correspond to the two electrical paths 51. Each of the two conductive patterns 212 has an end portion connected to the first voice coil 22 and another end connected to an end portion of the corresponding electrical path 51.

In some embodiments, each conductive pattern 212 may be a silver nanowire coating layer arranged on a side surface of the first diaphragm 21. In a case of the first voice coil 22 being attached to the first diaphragm 21, two connecting ends of the first voice coil 22 are electrically connected to end portions of the two silver nanowire coating layers respectively. The two conductive patterns 212 extend continuously from the first voice coil 22 to the edge of the first diaphragm 21, so as to facilitate their connection to the connecting member 5.

In some embodiments, as shown in FIG. 14, the first housing 31 has a connecting surface 311, and is connected to an edge of the first diaphragm 21 by means of the connecting surface 311. An avoidance groove 312 is formed in the connecting surface 311. As shown in FIG. 12, the connecting member 5 is a flexible printed circuit board. The flexible printed circuit board includes a first connecting end 52 and a second connecting end 53, and two ends of each electrical path 51 are arranged at the first connecting end 52 and the second connecting end 53 respectively. Referring to FIG. 4, the first connecting end 52 is arranged on an outer surface of the first housing 31, the second connecting end 53 extends into the avoidance groove 312 along outer surface of the first housing 31, and the end portions of the two electrical paths 51 are abutted against the two conductive patterns 212 respectively. In this embodiment, flexibility of the flexible printed circuit board is utilized, so that the flexible printed circuit board can be attached to the first housing 31, thereby reducing a volume occupied by the loudspeaker.

In some embodiments, the first connecting end 52 is arranged at an edge of the first installing surface 34. The second connecting end 53 extends from a side surface of the first housing 31 into the avoidance groove 312. Each electrical path 51 includes a first contact and a second contact. The first contact is exposed on the first connecting end 52 and faces one side, away from the first installing surface 34, of the first connecting end 52. The second contact is exposed on the second connecting end 53 and faces the first diaphragm 21. In a case of the first housing 31 and the second housing 32 clamping the edge of the first diaphragm 21, the second contact can just be abutted against the end portion of each conductive pattern 212, while the other end portion of each conductive pattern 212 extends toward the center of the first diaphragm 21 and is connected to the first voice coil 22. In this way, electrical connection between the connecting member 5 and the first voice coil 22 is achieved.

In some embodiments, as shown in FIG. 5, the seat 3 further includes a support lug 36, which is protruded from an outer surface of the second housing 32. The diaphragm film 211 includes an extension region 213, which is arranged at an edge of the diaphragm film 211 and extends to the support lug 36. The end portions of the two conductive patterns 212 extend into the extension region 213. The connecting member 5 is a rigid printed circuit board, i.e., a PCB. Two opposing board surfaces of the rigid printed circuit board respectively form the first connecting end 52 and the second connecting end 53, and two ends of each electrical path 51 are arranged at the first connecting end 52 and the second connecting end 53, respectively. The rigid printed circuit board is provided in the extension region 213, and end portions of the two electrical paths 51 arranged at the second connecting end 53 are abutted against the two conductive patterns 212, respectively.

In some embodiments, the support lug 36 extends horizontally toward a lateral side of the second housing 32. The support lug 36 is used for supporting the rigid printed circuit board and the extension region 213. After the rigid printed circuit board is installed in the extension region 213, the first contact is exactly oriented in a same direction as the first installing surface 34.

In some embodiments, as shown in FIGS. 1-4, the seat 3 is made from a non-magnetic-permeance magnetic material, and a plurality of air holes 37 are formed in the seat 3. The plurality of air holes 37 are staggered with respect to the first magnetic member 11 and the second magnetic member 12. In this way, the seat 3 made from the non-magnetic-permeance magnetic material can prevent the seat 3 from affecting a magnetic force of the magnetic assembly 1.

For example, the seat 3 may be made from a metallic material such as aluminum or copper, or as a non-metallic material such as plastics and rubber plastics. The first magnetic member 11 and the second magnetic member 12 each include a first magnetic ring 111, a second magnetic ring 112, and a third magnetic ring 113. Both the first installing surface 34 and the second installing surface 35 are provided with the air holes 37. The accommodating cavity 33 communicates with the outside by means of the air holes 37. The air holes 37 are uniformly formed in an outer side of the first magnetic ring 111.

In some embodiments, as shown in FIG. 5, the magnetic assembly 1 is configured in such a manner that a polarity of the first magnetic member 11 and a polarity of the second magnetic member 12 are of mirror symmetry. The south pole S of the third magnetic ring 113 is located on one side away from the first magnetic gap 41, and the north pole N of the third magnetic ring 113 is located on one side facing the first magnetic gap 41. The south pole S of the second magnetic ring 112 faces the first magnetic ring 111, and the north pole N of the second magnetic ring 112 faces the third magnetic ring 113. A polarity of the first magnetic ring 111 is opposite to that of the third magnetic ring 113.

Further, as shown in FIG. 8, the central magnet 15 is of a cylindrical structure, the north pole N of the central magnet 15 faces the accommodating cavity 33, and the south pole S of the central magnet 15 is located away from the accommodating cavity 33.

What stated above are merely exemplary embodiments of the present disclosure but are not used to limit the present disclosure, and various modifications and variations can be made in the present disclosure to those skilled in the art. Any modification, equivalent, improvement, etc. made within the spirit and principle of the present disclosure shall fall within the protection scope of the present disclosure.

What is claimed is:

1. A loudspeaker, comprising:
a seat, having an accommodating cavity;
a moving member, comprising a first diaphragm and a first voice coil arranged on the first diaphragm, wherein the first voice coil and at least a part of the first diaphragm are located in the accommodating cavity; and
a magnetic assembly, comprising a first magnetic member and a second magnetic member, which are arranged opposite to each other, wherein the first magnetic member and the second magnetic member are arranged on an outer side of the seat, a first magnetic gap is formed between the first magnetic member and the second magnetic member, and at least a part of the first voice coil is located in the first magnetic gap.

2. The loudspeaker according to claim 1, wherein the seat has a first installing surface and a second installing surface, which are located on outer surfaces of the seat, facing opposite directions; and
the first magnetic member is installed on the first installing surface, and the second magnetic member is installed on the second installing surface.

3. The loudspeaker according to claim 2, wherein the first installing surface and the second installing surface are planar surfaces, and the seat is in a cylinder shape.

4. The loudspeaker according to claim 2, wherein the moving member further comprises:
a second diaphragm; and
a second voice coil, fixedly connected to the second diaphragm and arranged on one side, away from the accommodating cavity, of the magnetic assembly, wherein at least a part of the second voice coil is located within a magnetic field of the magnetic assembly.

5. The loudspeaker according to claim 4, wherein the second voice coil is a planar voice coil.

6. The loudspeaker according to claim 4, wherein the magnetic assembly further comprises: a magnetic permeance washer, attracted to the first magnetic member,
wherein the second diaphragm is fixedly connected to one side, away from the first magnetic member, of the magnetic permeance washer, and the second voice coil is fixedly connected to one side, close to the first magnetic member, of the second diaphragm, and the second voice coil is located on an inner side of the magnetic permeance washer.

7. The loudspeaker according to claim 6, wherein the first magnetic member comprises a first magnetic ring, and the magnetic permeance washer is attracted to the first magnetic ring;
the magnetic assembly further comprises a central magnetic permeance member, the central magnetic permeance member comprises an inner plate and a cylinder, the inner plate is located on one side, close to the accommodating cavity, of the first magnetic ring and is attracted to the first magnetic ring, the cylinder extends outward from a center of the first magnetic ring, a part of the cylinder and the magnetic permeance washer form a second magnetic gap, and at least a part of the second voice coil is located in the second magnetic gap.

8. The loudspeaker according to claim 6, wherein the first magnetic member comprises a first magnetic ring, and the magnetic permeance washer is attracted to the first magnetic ring; and
at least a part of the second voice coil is spaced apart from and arranged opposite to the first magnetic ring.

9. The loudspeaker according to claim 8, wherein the first magnetic member further comprises a central magnet, which is located in the center of the first magnetic ring and is attracted to the first magnetic ring; and
the second voice coil is arranged opposite to both the central magnet and the first magnetic ring.

10. The loudspeaker according to claim 4, further comprising a circular cover provided on a side, away from the accommodating cavity, of the second diaphragm.

11. The loudspeaker according to claim 1, further comprising a connecting member arranged on the seat,
wherein the connecting member comprises an electrical path, and the electrical path comprises a first end located on the outer side of the seat and a second end electrically connected to the first voice coil.

12. The loudspeaker according to claim 11, wherein the first diaphragm comprises a diaphragm film and a conductive pattern formed on the diaphragm film, and the conductive pattern is arranged corresponding to the electrical path; and
the conductive pattern has one end connected to the first voice coil and another end connected to the second end of the electrical path.

13. The loudspeaker according to claim 12, wherein the conductive pattern is a silver nanowire coating layer arranged on a side surface of the first diaphragm.

14. The loudspeaker according to claim 12, wherein the seat comprises a first housing and a second housing, which are connected to form the accommodating cavity.

15. The loudspeaker according to claim 14, wherein the first housing comprises a connecting surface, the first housing is connected to an edge of the first diaphragm through the connecting surface, and the connecting surface comprises an avoidance groove.

16. The loudspeaker according to claim 15, wherein the connecting member comprises a first connecting end and a second connecting end, the first connecting end is arranged on an outer surface of the first housing, the second connecting end extends into the avoidance groove along the outer surface of the first housing, and the second end of the electrical path is abutted against the conductive pattern.

17. The loudspeaker according to claim 15, wherein the seat further comprises a support lug protruded from an outer surface of the second housing, the diaphragm film comprises an extension region, the extension region is arranged at an edge of the diaphragm film and extends to the support lug, an end portion of the conductive pattern extends into the extension region, and the electrical path is arranged on the support lug and is abutted against the conductive pattern.

18. The loudspeaker according to claim 1, wherein the seat is made from a non-magnetic-permeance material, a plurality of air holes are formed in the seat, and the plurality of air holes are staggered with the first magnetic member and the second magnetic member.

19. The loudspeaker according to claim 1, wherein the first voice coil is a planar voice coil.

20. The loudspeaker according to claim 1, wherein a polarity of the first magnetic member is mirror-symmetric to that of the second magnetic member.
